(19) United States
(12) Patent Application Publication
(10) Pub. No.: US 2024/0381193 A1
(43) Pub. Date: Nov. 14, 2024

(54) METHOD AND APPARATUS FOR MANAGING CONFIGURATION INFORMATION FOR CONTINUOUS CONDITIONAL PSCELL CHANGE IN WIRELESS COMMUNICATION SYSTEM

(71) Applicant: SAMSUNG ELECTRONICS CO., LTD., Suwon-si (KR)

(72) Inventors: Seungri JIN, Suwon-si (KR); June HWANG, Suwon-si (KR)

(21) Appl. No.: 18/658,889

(22) Filed: May 8, 2024

(30) Foreign Application Priority Data
May 10, 2023 (KR) 10-2023-0060581

(51) Int. Cl. H04W 36/00

(52) U.S. Cl. CPC H04W 36/0069; H04W 36/0061

(57) ABSTRACT

The disclosure relates to a 5G or 6G communication system for supporting a higher data transmission rate. Specifically, the disclosure provides a method and an apparatus for managing configuration information to efficiently support continuous conditional PSCell change. The method of UE comprises: receiving, from a base station, an RRC message including a configuration on a subsequent conditional PSCell addition or change (CPAC), the configuration including information on a candidate SCG configuration of a candidate PSCell and an MCG configuration associated with the candidate SCG configuration; and identifying the configuration included in the RRC message, wherein the configuration includes a reference configuration for the candidate SCG configuration.

### CROSS-REFERENCE TO RELATED APPLICATION

This application is based on and claims priority under 35 U.S.C. § 119 to Korean Patent Application No. 10-2023-0060581, filed on May 10, 2023, in the Korean Intellectual Property Office, the disclosure of which is herein incorporated by reference in its entirety.

### BACKGROUND

### 1. Field

The present disclosure relates to a wireless communication system. Specifically, the disclosure relates to the operations of a terminal and a base station in a wireless communication system and, more particularly, to a method and an apparatus for managing configuration information to efficiently support conditional primary secondary cell group cell (PSCell) change.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the recent development of a communication system, various demands for efficiently performing conditional primary secondary cell group (SCG) cell (PSCell) change are increasing.

The above information is presented as background information only to assist with an understanding of the disclosure. No determination has been made, and no assertion is made, as to whether any of the above might be applicable as prior art with regard to the disclosure.

### SUMMARY

The disclosure is to provide a method and an apparatus for improving conditional primary SCG cell (PSCell) addition (CPA) and conditional PSCell change (CPC) or conditional PSCell addition and change (CPAC) applied to an existing NR system. Specifically, when all candidate SCG configurations stored in a terminal are released after secondary cell group (SCG) change is performed, continuous CPAC operation is not possible. In other words, once CPAC is applied and performed in a terminal, in order for the terminal to perform CPAC operation again, the base station may provide CPAC configuration to the terminal again through radio resource control (RRC) configuration. The disclosure provides a method for enabling a continuous conditional PSCell change and allowing a master cell group (MCG) change to be performed during the corresponding operation.

Based on the foregoing discussion, the disclosure may provide a method of processing a control signal in a wireless communication system, the method including receiving a first control signal transmitted from a base station, processing the received first control signal, and transmitting a second control signal generated based on the processing to the base station.

According to embodiments provided in the disclosure, the base station may provide candidate SCG configurations and instructions to the terminal to support continuous CPAC, so as to allow the terminal to keep the corresponding configuration even after changing the SCG configuration. Accordingly, the base station may support continuous CPAC operation according to channel conditions without additional RRC configuration, thereby reducing unnecessary RRC signaling and enabling dynamic CPAC operation tailored to channel conditions. In addition, the base station may transfer and manage CPC and CPA-related configuration (e.g., conditions for CPA and CPC and configurations applied after handover) to a terminal at once, thereby reducing the burden of additional RRC configuration. The terminal is able to perform CAPC continuously as described above, thereby enabling CAPC to effectively reflect changes in channel conditions. In addition, the MCG change may be performed during the CAPC operation, and thus a procedure for managing a cell group by the terminal can be simplified.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of an LTE system according to various embodiments of the disclosure;

FIG. 2 illustrates a radio protocol structure of an LTE system according to various embodiments of the disclosure;

FIG. 3 illustrates a structure of a next-generation mobile communication system according to various embodiments of the disclosure;

FIG. 4 illustrates a radio protocol structure of a next-generation mobile communication system according to various embodiments of the disclosure

FIG. 5 illustrates a method for performing a conditional PSCell addition procedure in an LTE system or NR system according to various embodiments of the disclosure;

FIG. 6 illustrates a method for performing a conditional PSCell change procedure in an LTE system or NR system according to various embodiments of the disclosure;

FIG. 7 illustrates a method for simultaneously performing CPAC configurations provided in the disclosure in order to perform a conditional PSCell addition and change procedure continuously according to various embodiments of the disclosure;

FIG. 8A illustrates a method for performing a conditional PSCell addition and change procedure continuously according to various embodiments of the disclosure;

FIG. 8B illustrates a method for performing a conditional PSCell addition and change procedure continuously according to various embodiments of the disclosure;

FIG. 9 illustrates a method of a UE operation when conditional PSCell addition and change are continuously applied according to various embodiments of the disclosure;

FIG. 10 illustrates method of a base station operation when conditional PSCell addition and change are continuously applied according to various embodiments of the disclosure;

FIG. 11 illustrates an internal structure of a UE according to various embodiments of the disclosure; and

FIG. 12 illustrates a configuration of a base station according to various embodiments of the disclosure.

### DETAILED DESCRIPTION

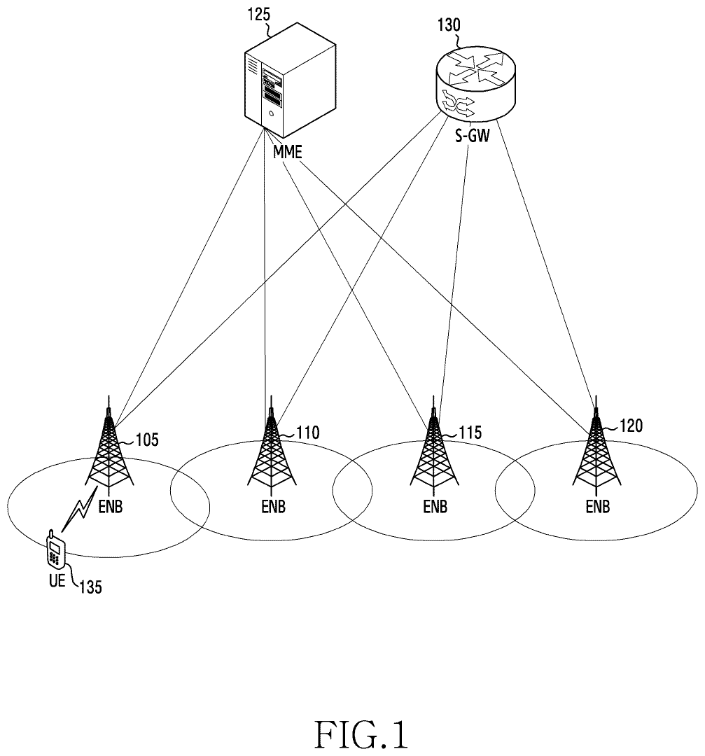

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail with reference to the accompanying drawings. In describing the disclosure below, detailed descriptions of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, the terms “physical channel” and “signal” may be interchangeably used with the term “data” or “control signal.” For example, the term “physical downlink shared channel (PDSCH)” refers to a physical channel over which data is transmitted, but the PDSCH may also be used to refer to the “data.” That is, in the disclosure, the expression “transmit ting a physical channel” may be construed as having the same meaning as the expression “transmitting data or a signal over a physical channel.”

In the following description of the disclosure, higher signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description of the disclosure, terms and names defined in the 3rd generation partnership project new radio (3GPP NR) or 3GPP long term evolution (3GPP LTE) standards will be used for the sake of descriptive convenience. However, the disclosure is not limited by these terms and names, and may be applied in the same way to systems that conform other standards. In the disclosure, the term “g NB” may be interchangeably used with the term “e NB” for the sake of descriptive convenience. That is, a base station described as “eNB” may indicate “gNB.” Furthermore, the term “terminal” may refer to a mobile phone, an MTC device, an NB-IoT device, a sensor, and other wireless communication devices.

In the following description, a base station (BS) is an entity that allocates resources to terminals, and may be at least one of a gNode B (gNB), an eNode B (eNB), a Node B, a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). The disclosure may be applied to intelligent services (e.g., smart homes, smart buildings, smart cities, smart cars or connected cars, healthcare, digital education, retail business, security, and safety-related services, etc.) on the basis of 5G communication technology and IoT-related technology. In the disclosure, the term “eNB” may be interchangeably used with the term “gNB” for the sake of descriptive convenience. That is, a base station described as “eNB” may indicate “gNB.” Also, the term “terminal” may refer to a mobile phone, an NB-IoT device, a sensor, and other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a terminal transmits data or control signals to a base station, and the downlink indicates a radio link through which the base station transmits data or control signals to the terminal. The above multiple access scheme separates data or control information of respective users by allocating and operating time-frequency resources for transmitting the data or control information for each user so as to avoid overlapping each other, that is, so as to establish orthogonality.

Since a 5G communication system, which is a communication system subsequent to LTE, may freely reflect various requirements of users, service providers, and the like, services satisfying various requirements may be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB may provide a peak data rate of 20 Gbps in the downlink and a peak data rate of 10 Gbps in the uplink for a single base station. Furthermore, the 5G communication system may provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system, mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it may support a large number of UEs (e.g., 1,000,000 UEs/km\hat{ }2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC may be configured to be inexpensive, and may require a very long battery lifetime such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC may provide communication with ultra-low latency and ultra-high reliability. For example, a service supporting URLLC may satisfy an air interface latency of less than 0.5 ms, and may also require a packet error rate of 10\hat{ }-5 or less. Therefore, for the services supporting URLLC, a 5G system may provide a transmit time interval (TTI) shorter than those of other services, and also may require a design for assigning a large number of resources in a frequency band in order to secure reliability of a communication link.

The above described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely an example of different types of services, and service types to which the disclosure is applied are not limited to the aforementioned examples.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

FIG. 1 illustrates a structure of an LTE system according to various embodiments of the disclosure.

Referring to FIG. 1, as illustrated therein, a radio access network of an LTE system includes next-generation base stations (evolved node Bs, hereinafter eNBs, node Bs, or base stations) 105, 110, 115, and 120, a mobility management entity (MME) 125, and a serving gateway (S-GW) 130. A user equipment (hereinafter UE or terminal) 135 accesses an external network through the eNBs 105 to 120 and the S-GW 130.

In FIG. 1, the eNBs 105 to 120 correspond to conventional node Bs of a universal mobile telecommunication system (UMTS). The eNBs are connected to the UE 135 through a radio channel, and perform more complicated roles than the conventional node Bs. In the LTE system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is required, and the eNBs 105 to 120 serves as the device. In general, one eNB controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. Furthermore, the LTE system employs an adaptive modulation & coding (hereinafter referred to as AMC) scheme for determining a modulation scheme and a channel coding rate according to a channel state of the UE. The S-GW 130 is a device that provides a data bearer and generates or removes a data bearer under the control of the MME 125. The MME is responsible for various control functions as well as a mobility management function for a UE and is connected to multiple base stations.

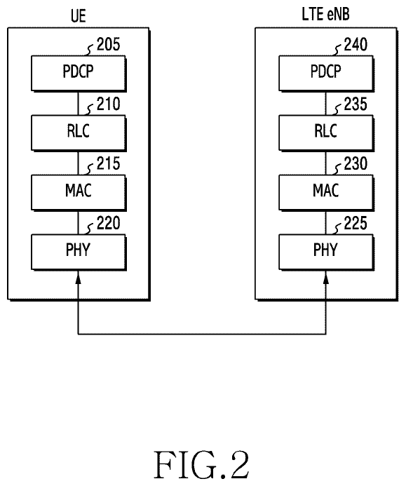

FIG. 2 illustrates a radio protocol structure of an LTE system according to various embodiments of the disclosure.

Referring to FIG. 2, a radio protocol of an LTE system includes a packet data convergence protocol (PDCP) 205 or 240, a radio link control (RLC) 210 or 235, and a medium access control (MAC) 215 or 230 in each of a UE and an eNB. The PDCP 205 or 240 is responsible for operations such as IP header compression/reconstruction. The main functions of the PDCP are summarized as follows:
Header compression and decompression: ROHC only;
Transfer of user data;
In-sequence delivery of upper layer protocol data units (PDUs) at PDCP re-establishment procedure for RLC acknowledged mode (AM);
For split bearers in dual connectivity (DC) (only support for RLC AM): PDCP PDU routing for transmission and PDCP PDU reordering for reception;
Duplicate detection of lower layer service data units (SDUs) at PDCP re-establishment procedure for RLC AM;
Retransmission of PDCP SDUs at handover and, for split bearers in DC, of PDCP PDUs at PDCP data-recovery procedure, for RLC AM;
Ciphering and deciphering; and/or
Timer-based SDU discard in uplink.

The radio link control (hereinafter RLC) 210 or 235 reconfigures a PDCP protocol data unit (PDU) into an appropriate size to perform an automatic repeat request (ARQ) operation. The main functions of the RLC are summarized as follows:
Transfer of upper layer PDUs;
Error Correction through ARQ (only for AM data transfer);
Concatenation, segmentation, and reassembly of RLC SDUs (only for UM and AM data transfer);
Re-segmentation of RLC data PDUs (only for AM data transfer);
Reordering of RLC data PDUs (only for UM and AM data transfer);
Duplicate detection (only for UM and AM data transfer);
Protocol error detection (only for AM data transfer);
RLC SDU discard (only for UM and AM data transfer); and/or
RLC re-establishment.

The MAC 215 or 230 is connected to several RLC layer devices configured in a single terminal and performs operations of multiplexing RLC PDUs to a MAC PDU and demultiplexing a MAC PDU to RLC PDUs. The main functions of the MAC are summarized as follows:
Mapping between logical channels and transport channels;
Multiplexing/demultiplexing of MAC SDUs belonging to one or different logical channels into/from transport blocks (TB) delivered to/from the physical layer on transport channels
Scheduling information reporting;
HARQ (Error correction through HARQ);
Priority handling between logical channels of one UE;
Priority handling between UEs by means of dynamic scheduling;
Multimedia broadcast and multicast service (MBMS) service identification;
Transport format selection; and/or
Padding.

A physical (PHY) layer 220 or 225 performs operations of channel-coding and modulating upper layer data, thereby generating the same into OFDM symbols, and transmitting the same through a radio channel, or demodulating the OFDM symbols received through the radio channel, channel-decoding the same, and delivering the same to the upper layer. For additional error correction, the PHY layer also uses hybrid ARQ (HARQ), and a receiving end uses one bit to transmit whether a packet transmitted by a transmitting end is received. This is referred to as HARQ AQCK/NACK information. HARQ ACK/NACK information in response to uplink transmission may be transmitted through a physical hybrid-ARQ indicator channel (PHICH), and HARQ ACK/NACK information in response to downlink transmission may be transmitted through a physical uplink control channel (PUCCH) or physical uplink shared channel (PUSCH).

The PHY layer may include one or multiple frequencies/carriers, and a technology for simultaneously configuring and using multiple frequencies is referred to as carrier aggregation (hereinafter CA). The CA refers to a technology in which, instead of using only one carrier for communication between a UE and an E-UTRAN node B (eNB), one primary carrier and multiple secondary carriers are additionally used and thus data capacity may be greatly increased as much as the number of secondary carriers. In LTE, a cell in an eNB using the primary carrier may be referred to as a primary cell (PCell) and a cell in an eNB using the secondary carrier may be referred to as a secondary cell (SCell).

Although not illustrated, radio resource control (hereinafter RRC) layers may exist as higher layers than the PDCP layers of the UE and the eNB, respectively, and for radio resource control, the RRC layers may exchange configuration control messages related to access and measurement.

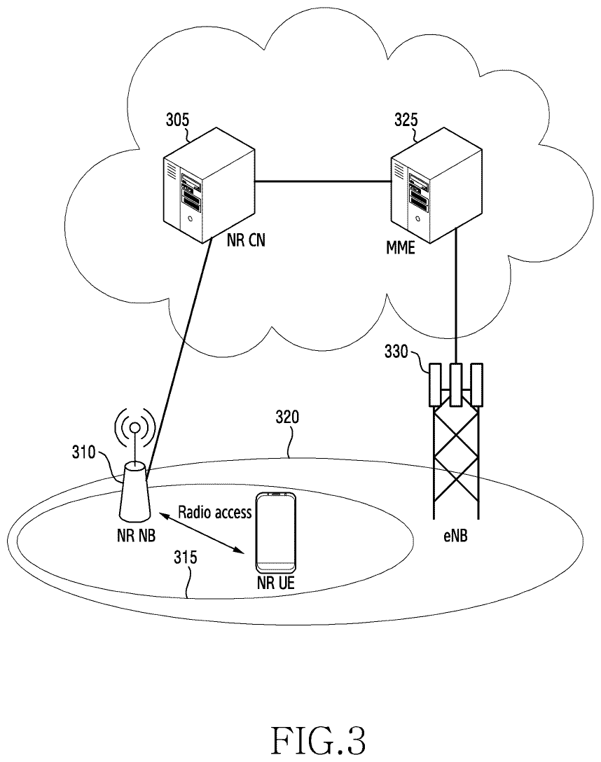

FIG. 3 illustrates a structure of a next-generation mobile communication system according to various embodiments of the disclosure.

Referring to FIG. 3, as illustrated therein, a radio access network of a next-generation mobile communication system includes a next-generation base station (new radio node B, hereinafter NR NB) 310, and a new radio core network (NR CN) or next generation core network (NG CN) 305. A user terminal (new radio user equipment, hereinafter NR UE or NR terminal) 335 accesses an external network via the NR NB 310 and the NR CN 305.

In FIG. 3, the NR NB 310 corresponds to an evolved node B (eNB) of a conventional LTE system. The NR NB is connected to the NR UE 315 through a radio channel, and may provide outstanding services as compared to a conventional node Bs. In the next-generation mobile communication system, since all user traffic is serviced through a shared channel, a device that collects state information, such as buffer statuses, available transmit power states, and channel states of UEs, and performs scheduling accordingly is required, and the NR NB 310 serves as the device. In general, one NR NB controls multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation and coding (AMC) scheme for determining a modulation scheme and a channel coding rate according to a channel state of the UE. The NR CN 305 performs functions such as mobility support, bearer configuration, and QoS configuration. The NR CN is a device responsible for various control functions as well as a mobility management function for a UE and is connected to multiple base stations. In addition, the next-generation mobile communication system may interwork with the existing LTE system, and the NR CN is connected to an MME 325 via a network interface. The MME is connected to an eNB 330 that is a conventional base station.

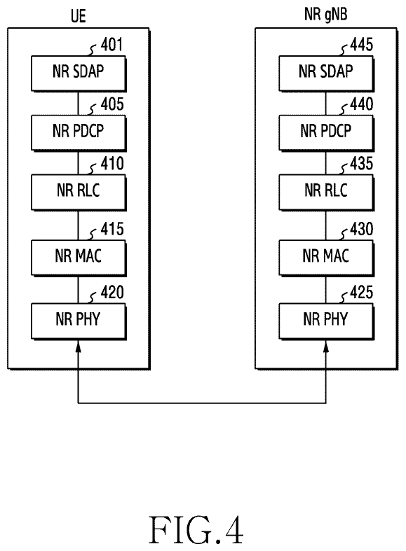

FIG. 4 illustrates a radio protocol structure of a next-generation mobile communication system according to various embodiments of the disclosure.

Referring to FIG. 4, a radio protocol of a next-generation mobile communication system includes an NR service data adaptation protocol (SDAP) 401 or 445, an NR PDCP 405 or 440, an NR RLC 410 or 435, and an NR MAC 415 or 430 in each of a UE and an NR base station.

The main functions of the NR SDAP 401 or 445 may include some of functions below:
Transfer of user plane data;
Mapping between a QoS flow and a data radio bearer (DRB) for both downlink (DL) and uplink (UL);
Marking QoS flow ID in both DL and UL packets; and/or
Reflective QoS flow to DRB mapping for UL SDAP PDUs.

With regard to the SDAP layer device, the UE may be configured, through an RRC message, whether to use the header of the SDAP layer device or whether to use functions of the SDAP layer device for each PDCP layer device or each bearer or each logical channel. If an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority for providing efficient services, scheduling information, or the like.

The main functions of the NR PDCP 405 or 440 may include some of functions below:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

The reordering of the NR PDCP device refers to a function of reordering PDCP PDU received from a lower layer in an order based on PDCP sequence numbers (SNs), and may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 410 or 435 may include some of functions below:
Transfer of upper layer PDUs;
In-sequence delivery of upper layer PDUs;
Out-of-sequence delivery of upper layer PDUs;
Error Correction through ARQ;
Concatenation, segmentation, and reassembly of RLC SDUs;
Re-segmentation of RLC data PDUs;
Reordering of RLC data PDUs;
Duplicate detection;
Protocol error detection;
RLC SDU discard; and/or
RLC re-establishment.

The above-mentioned in-sequence delivery of the NR RLC device refers to a function of successively delivering RLC SDUs received from the lower layer to the upper layer, and may include a function of reassembling and delivering multiple RLC SDUs received, into which one original RLC SDU has been segmented, may include a function of reordering the received RLC PDUs with reference to the RLC SN or PDCP SN, may include a function of recording RLC PDUs lost as a result of reordering, may include a function of reporting the state of the lost RLC PDUs to the transmitting side, may include a function of requesting retransmission of the lost RLC PDUs, may include a function of, if there is a lost RLC SDU, successively delivering only RLC SDUs before the lost RLC SDU to the upper layer, may include a function of, if a predetermined timer has expired although there is a lost RLC SDU, successively delivering all RLC SDUs received before the timer was started to the upper layer, or may include a function of, if a predetermined timer has expired although there is a lost RLC SDU, successively delivering all currently received RLC SDUs to the upper layer. In addition, the RLC PDUs may be processed in the received order (regardless of the sequence number order, in the order of arrival) and delivered to the PDCP device regardless of the order (out-of-sequence delivery). In the case of segments, segments which are stored in a buffer, or which are to be received later, may be received, reconfigured into one complete RLC PDU, processed, and delivered to the PDCP device. The NR RLC layer may include no concatenation function, which may be performed in the NR MAC layer or replaced with a multiplexing function of the NR MAC layer.

The out-of-sequence delivery function of the NR RLC device refers to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 415 or 430 may be connected to several NR RLC layer devices configured in a single UE, and the main functions of the NR MAC may include some of functions below:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

An NR PHY layer 420 or 425 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

In the following referenced drawings and provided embodiments of the disclosure, an enhancement technique for primary secondary cell group (SCG) cell (PSCell) addition and change (PSCell addition and change), particularly, conditional PSCell addition and change (CPC and CPA, CPAC) procedure is considered. The disclosure provides methods capable of maintaining the corresponding configurations and conditions so that CPAC can be triggered continuously, instead of performing configuration release for the candidate secondary node (SN) configured by the base station, even after SCG change is performed for a previously supported CPAC operation. In particular, the disclosure provides a method of enabling not only SCG configuration but also MCG configuration to be changed when, in a state in which dual connectivity (DC) is not configured in a terminal, configurations for both CPA and CPC are received at once and the terminal performs SCG addition and change. Hereinafter, the disclosure provides an overall operation of allowing the configurations received for the CPA and CPC to be maintained even after the CPAC.

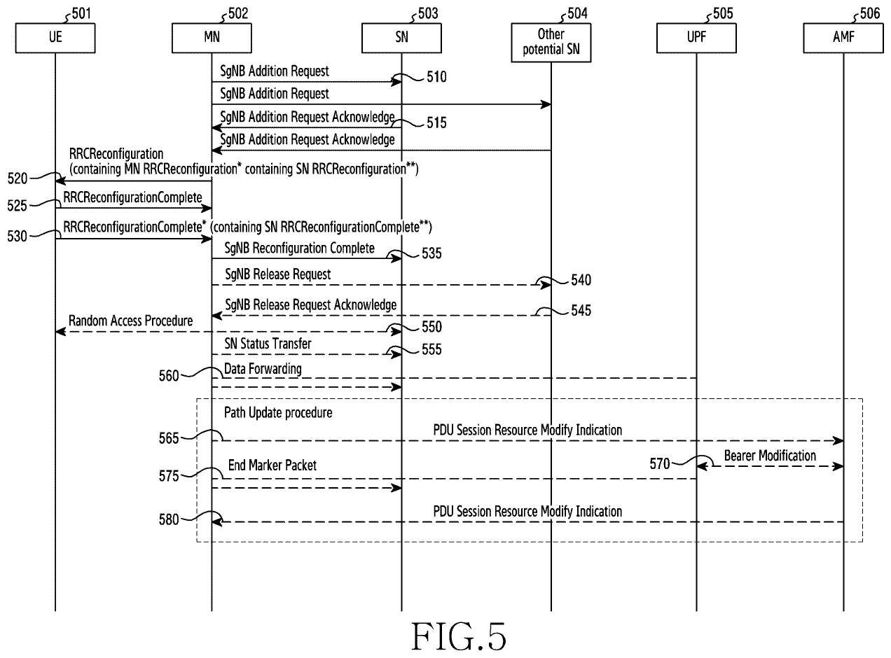

FIG. 5 illustrates a method for performing a conditional PSCell addition procedure in an LTE system or NR system according to various embodiments of the disclosure.

A UE 501 in an RRC connected state performs data transmission/reception and channel measurement/reporting operations according to the configurations of a connected master node (MN)/base station 502. Further, the MN base station 502 identifies whether it is necessary to add an SN for the UE and inquires of SN nodes that can be candidates (or potential SN nodes) about whether the SN nodes are available for SN addition for the UE. The corresponding procedure is performed through sgNB addition request procedure (in operation 510) and sgNB addition request acknowledgement procedure (in operation 515) between the MN base station and the respective SN nodes. In operation 520, the MN base station 502 includes the CPA-related configuration (i.e., condition for CPA and SCG-related RRC configuration) received from the candidate SNs that allowed the SN addition in operations 510/515 in an RRC configuration message of the MN and transfers the same to the UE. In the EN-DC situation, the CPA-related configuration for the SN is encapsulated in an RRCConnectionReconfiguration message, and in the NE-DC and NR-DC situations, the CPA-related configuration for the SN is encapsulated in the RRCReconfiguration message and transferred to the UE.

With reference to FIG. 5, the case of NR-DC will be assumed and described. Up to 8 SN CPA configurations, which are included in the RRC configuration, may be provided through ConditionalReconfiguration as shown in Table 1 below. For reference, the corresponding configurations are the same as the maximum number of configurations related to MN CHO and SN CPAC, and the base station may configure up to 8 configurations by considering both the MN CHO and SN CPAC. Among the SN CPAC-related configurations, condReconfigId refers to the index of the corresponding SN CPAC configuration, and includes condExecutionCond, which is the condition for SN CPA and indicated by measId, and condRRCReconfig including the SCG configuration to be applied after the UE performs SN CPA. The condition (condExecutionCond) for SN CPA may include up to two trigger conditions, and one RS type and up to two different trigger quantities (e.g., RSRP and RSRQ, RSRP and SINR, etc.) may be provided as the conditions.

```
TABLE 1
  ConditionalReconfiguration-r16 ::= SEQUENCE {
    attemptCondReconfig-r16 ENUMERATED {true} OPTIONAL, -- Cond CHO
    condReconfigToRemoveList-r16 CondReconfigToRemoveList-r16 OPTIONAL, -
- Need N
    condReconfigToAddModList-r16 CondReconfigToAddModList-r16 OPTIONAL,
-- Need N
  ...
  CondReconfigToAddModList-r16 ::= SEQUENCE (SIZE (1.. maxNrofCondCells-
r16)) OF CondReconfigToAddMod-r16
  CondReconfigToAddMod-r16 ::= SEQUENCE {
    condReconfigId-r16 CondReconfigId-r16,
    condExecutionCond-r16 SEQUENCE (SIZE (1..2)) OF MeasId OPTIONAL, --
Need M
    condRRCReconfig-r16 OCTET STRING (INCLUDING RRCReconfiguration)
OPTIONAL, -- Cond condReconfigAdd
    ...,
    [[
    condExecutionCondSCG-r17 OCTET STRING (INCLUDING
CondReconfigExecCondSCG-r17) OPTIONAL -- Need M
  ]]
  }
  CondReconfigExecCondSCG-r17 ::= SEQUENCE (SIZE (1..2)) OF MeasId
```

In operation 525, the UE transfers an RRCReconfigurationComplete message to the MN base station 502 in response to the received RRC configuration (which may include the configuration for MN and SN, and particularly may include CPA-related configuration). Thereafter, in case that the CPA-related condition received from a particular SN is satisfied, the UE 501 triggers a procedure of SN addition for the corresponding SN. In other words, in operation 530, the UE generates MN RRCReconfigurationComplete including the SN RRCReconfigurationComplete message for the SN for which the SN addition procedure is triggered (the SN for which the CPA condition is satisfied) and transfers the same to the MN base station 502.

In operation 535, the MN base station 502 transfers the sgNB reconfiguration complete message to the SN base station 503 for which the corresponding CPA condition is satisfied, that is, the SN base station 503 to which the UE performs the SN addition and notifies the SN base station 503 of the SN addition operation of the UE. In addition, in operation 540, the MN base station 502 transfers a sgNB release request message, which indicates release of the SCG configuration transferred to the UE, to the candidate SN base stations to which SN addition is not performed. In operation 545, the respective candidate SNs transfer sgNB release request Acknowledge to the MN base station in response to the message. Operations 540 and 545 may be omitted depending on implementations.

In operation 550, the UE performs a random access procedure for SN addition to the SN for which the CPA is triggered. This operation is performed only when the update of security key is required, and may be omitted in other cases. In operation 555, the MN base station 502 transfers a sequence number (SN) status to the SN base station 503, and in operation 560, the MN base station 502 performs a procedure of transferring data from a user plane function (UPF) 505 to the SN base station 503. In addition, in operation 565, as an operation for path update, the MN base station 502 transfers a PDU session resource modification indicator to an access and mobility management function (AMF) 506. In operation 570, the AMF 506 and the UPF 505 perform a bearer modification procedure, and in operation 575, the UPF 505 transfers a PDU packet including an end marker to the MN base station 502 to indicate the modification of the previous bearer. In operation 580, the AMF 506 transfers, to the MN base station 502, a PDU session resource modification identification message indicating that the PDU session resource modification has been completed.

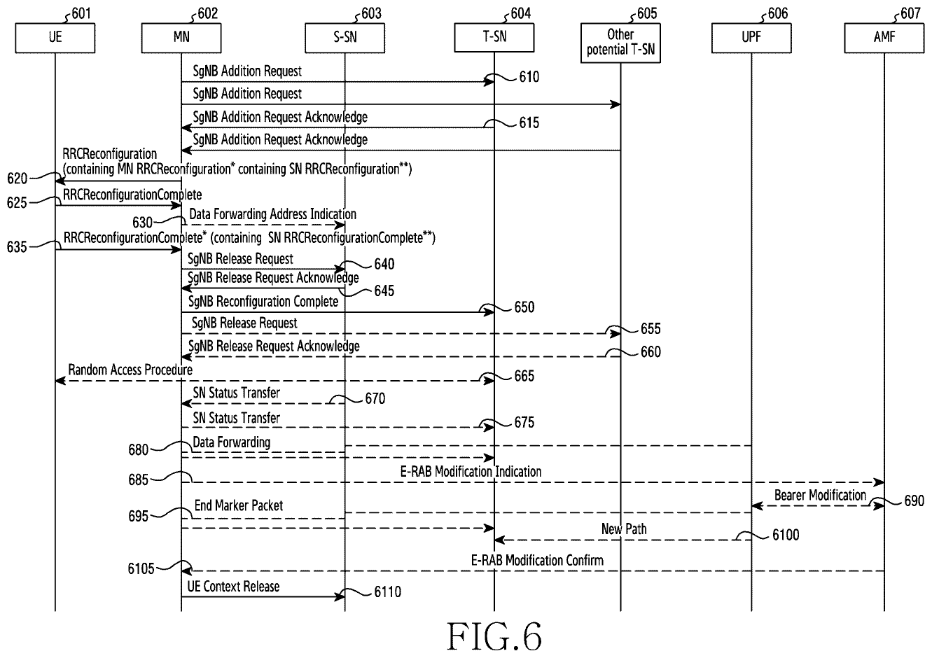

FIG. 6 illustrates a method for performing a conditional PSCell change procedure in an LTE system or NR system according to various embodiments of the disclosure.

The UE 601 in an RRC connected state performs data transmission/reception and channel measurement/reporting operations according to the configurations of the connected Master Node (MN)/base station 602. Further, the MN base station 602 identifies whether it is necessary to change the current source SN base station 603 to other SN base stations 604 and 605, and inquires of the SN nodes 604 and 605 that can be candidates (or potential SN nodes) about whether the SN base stations are available for SN change for the UE. The corresponding procedure is performed through sgNB addition request procedure (in operation 610) and sgNB addition request Acknowledgment procedure (in operation 615) between the MN base station 602 and the respective SN nodes 604 and 605. In operation 620, the MN base station 602 includes the CPC-related configuration (condition for CPC and SCG-related RRC configuration) received from candidate SNs 604 and 605 that allow the SN addition and change in operations 610/615 in an RRC configuration message of the MN base station and transmit the same to the UE.

In the EN-DC situation, the CPC-related configuration for the SN is encapsulated in the RRCConnectionReconfiguration message, and in the NE-DC and NR-DC situations, the CPC-related configuration for the SN is encapsulated in the RRCReconfiguration message and transferred. With reference to FIG. 1F, the case of NR-DC will be assumed and described. The SN CPC-related configuration included in the RRC configuration may be provided with up to 8 SN CPC configurations through ConditionalReconfiguration as shown in Table 2 below. For reference, the number of configurations is the same as the maximum number of MN CHO and SN CPC-related configuration, and the base station may configure up to 8 configurations by considering both the MN CHO and SN CPC. Among the SN CPC-related configuration, condReconfigId refers to the index of the corresponding SN CPC configuration, and includes condExecutionCond, which is a condition for SN CPC and indicated by measId, and condRRCReconfig, which contains the SCG configuration applied after the UE performs the SN CPC. Conditions (condExecutionCond) for the SN CPC may include up to two trigger conditions and may be provided with one RS type and up to two different trigger quantities (e.g., RSRP and RSRQ, RSRP and SINR, etc.) as the conditions.

```
TABLE 2
  ConditionalReconfiguration-r16 ::= SEQUENCE {
    attemptCondReconfig-r16  ENUMERATED {true}  OPTIONAL, -- Cond CHO
    condReconfigToRemoveList-r16  CondReconfigToRemoveList-r16 OPTIONAL, -
- Need N
    condReconfigToAddModList-r16  CondReconfigToAddModList-r16 OPTIONAL,
-- Need N
  ...
  CondReconfigToAddModList-r16  ::=  SEQUENCE  (SIZE  (1..  maxNrofCondCells-
r16)) OF CondReconfigToAddMod-r16
  CondReconfigToAddMod-r16 ::=  SEQUENCE {
    condReconfigId-r16  CondReconfigId-r16,
    condExecutionCond-r16  SEQUENCE (SIZE (1..2)) OF MeasId  OPTIONAL, --
Need M
    condRRCReconfig-r16  OCTET STRING (INCLUDING RRCReconfiguration)
OPTIONAL, -- Cond condReconfigAdd
    ...,
    [[
    condExecutionCondSCG-r17  OCTET  STRING  (INCLUDING
CondReconfigExecCondSCG-r17) OPTIONAL -- Need M
  ]]
  }
  CondReconfigExecCondSCG-r17 ::= SEQUENCE (SIZE (1..2)) OF MeasId
```

In operation 625, the UE may transfer an RRCReconfigurationComplete message to the MN base station 602 in response to the received RRC configuration (including the configuration for the MN and SN, especially CPC-related configuration), and in operation 630, the UE may indicate a data forwarding address to the source SN base station 603. According to the embodiment, operation 630 may be omitted.

Thereafter, when the CPC-related conditions received from the specific SN are satisfied, the UE triggers the SN change procedure for the corresponding SN. In other words, in operation 635, the UE generates an MN RRCReconfigurationComplete including an SN RRCReconfigurationComplete message for the SN for which the SN change procedure is triggered (the SN for which the CPC condition is satisfied) and transfers the same to the MN base station 602.

In operation 640, the MN base station 602 transfers, to the source SN base station 603, a sgNB release request message requesting the release of SCG configuration, and in operation 645, the source SN base station 603 responds to the request by transferring sgNB release request acknowledgment message. In operation 650, the MN base station 602 transfers sgNB reconfiguration complete message to a target SN base station 604 for which the corresponding CPC condition is satisfied, that is, the target SN base station 604 to which the UE performs the SN change, and thus notifies of the SN change operation of the UE. In addition, in operation 655, the MN base station 602 transfers, to the candidate SN base stations 605 for which the SN change has not been performed, a sgNB release request message indicating the release of the SCG configuration transferred to the UE. Furthermore, in operation 660, the respective candidate SN base stations 605 transfer SgNB release request acknowledge in response to the message. Operations 655 and 660 may be omitted according to the implementation.

In operation 665, the UE performs a random access procedure for SN change with respect to the target SN for which the CPC is triggered. This operation is performed only in the case where the update of security key is required, and may be omitted in other cases. In operation 670, the MN base station 602 receives a sequence number (SN) status from the source SN base station 603, and in operation 675, the MN base station 602 transfers the received sequence number (SN) status to the target SN base station 604. In operation 680, the MN base station 602 performs a procedure of transferring data from the UPF 606 to the target SN base station 604. Furthermore, in operation 685, as an operation for the path update, the MN base station 602 transfers a PDU session resource modification indicator to the AMF 607. In operation 690, the AMF 607 and the UPF 606 perform the bearer modification procedure and, in operation 695, the UPF 606 transfers a PDU packet including an end marker to the MN base station 602 to indicate the modification of the previous bearer. In operation 6100, the UPF 606 indicates a new path to the target SN base station 604. In operation 6105, the AMF 607 transfers, to the MN base station 602, a PDU session resource modification identification message indicating that the PDU session resource modification has been completed and, in operation 6110, the MN base station 602 indicates the source SN base station 603 to release the UE context.

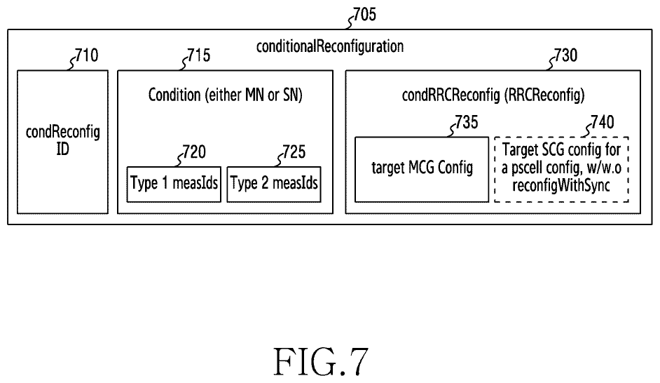

FIG. 7 illustrates a method for simultaneously performing CPAC configurations in order to perform a conditional PSCell addition and change procedure continuously according to various embodiments of the disclosure. First, an example of a scenario applied in connection with a method of simultaneously configuring CPA and CPC configurations for the continuous conditional PSCell addition and change procedure, which are featured in the embodiments of the disclosure, will be described below.
1. Stage 1: A state in which a terminal is in a single RRC connection to a serving cell (PCell, cell A) (single connectivity state with no DC configured).
2. Stage 2: The terminal simultaneously receives, from a serving cell (PCell, Cell A), CPA and CPC configurations for the continuous conditional PSCell addition and change procedure.
3. Stage 3: The terminal adds cell B existing in SN1 to PSCell according to the configured CPA procedure.
4. Stage 4: The terminal changes the PSCell to cell C existing in SN2 according to the configured CPC procedure.
5. Stage 5: The terminal change PSCell again to cell B existing in SN1 according to the configured CPC procedure.

In other words, the above scenario is a scenario in which DC is established via CPA and then PSCell change is performed continuously via CPC in a state in which the terminal is in an RRC connection to a PCell. The operation according to the current standard is different from the above scenario because only CPA configuration is transferred to the terminal in the single connectivity state and then, if DC is established, the previous CPA configuration is deleted and CPC configuration is added. In particular, the above scenario is mainly characterized in that, in operation 2, the serving cell base station simultaneously transfers the CPA configuration and the CPC configuration to the terminal in the single connectivity state, and the terminal stores and maintains the configurations and performs the CPAC procedure.

With reference to FIG. 7, the case of NR-DC will be assumed and described. As for the SN CPA-related configuration included in the RRC configuration, up to 8 SN CPA configurations may be provided via ConditionalReconfiguration 705 as described in below. For reference, the number of the corresponding configurations is the same as the maximum number of MN CHO and SN CPAC-related configurations, and the base station may configure up to 8 configurations by considering both the MN CHO and SN CPAC. Among the SN CPAC-related configurations, condReconfigId 710 refers to the index of the corresponding SN CPAC configuration, and includes condExecutionCond 715, which is a condition for SN CPC and indicated by measIds 720 and 725, and condRRCReconfig 730, which contains the SCG configuration applied after the UE performs the SN CPC. A target MCG configuration 735 and a SCG configuration 735 for the target PSCell may be transmitted simultaneously to the condRRCReconfig 730 including the SCG configuration.

Traditionally, the condition (condExecutionCond) for SN CPA may include up to two trigger conditions, and one RS type and up to two different trigger quantities (e.g., RSRP and RSRQ, RSRP and SINR, etc.) may be provided as conditions. ASN.1 in Table 3 below is the structure of the current RRC signaling for reference.

```
TABLE 3
  ConditionalReconfiguration-r16 ::= SEQUENCE {
    attemptCondReconfig-r16  ENUMERATED {true}  OPTIONAL, -- Cond CHO
    condReconfigToRemoveList-r16  CondReconfigToRemoveList-r16 OPTIONAL,
-- Need N
    condReconfigToAddModList-r16  CondReconfigToAddModList-r16 OPTIONAL,
-- Need N
  ...
  CondReconfigToAddModList-r16  ::=  SEQUENCE  (SIZE  (1..  maxNrofCondCells-
r16)) OF CondReconfigToAddMod-r16
  CondReconfigToAddMod-r16 ::=  SEQUENCE {
    condReconfigId-r16  CondReconfigId-r16,
    condExecutionCond-r16  SEQUENCE (SIZE (1..2)) OF MeasId  OPTIONAL, -
- Need M
    condRRCReconfig-r16  OCTET STRING (INCLUDING RRCReconfiguration)
OPTIONAL, -- Cond condReconfigAdd
    ...,
    [[
    condExecutionCondSCG-r17  OCTET  STRING  (INCLUDING
CondReconfigExecCondSCG-r17) OPTIONAL -- Need M
  ]]
  }
  CondReconfigExecCondSCG-r17 ::= SEQUENCE (SIZE (1..2)) OF MeasId
```

FIG. 7 illustrates a signaling structure according to various embodiments of the disclosure, and this structure is applied to the following embodiments. In addition, the CPA and CPC condition and configuration information provided in the disclosure are characterized in that a delta configuration is basically applied thereto. Here, the delta configuration refers to a method of providing, through a configuration, only the part showing a difference in the conditions and configurations for CPAC candidate cells, based on a reference cell and a configuration of the reference cell. From the perspective of a receiving terminal, both the reference cell configuration and the delta configuration of candidate cells are used to decode and store/manage the actual configurations of the candidate cells. Particularly, the MCG configuration, which is applied after continuous conditional PSCell change is performed, as identified by reference numeral 735, may be transferred together. To this end, the disclosure provides a detailed configuration method.

Particularly, the disclosure provides a method of transferring MCG configuration through a configuration for a reference cell applied to SCG configuration (SCG reference cell configuration) and a configuration for a reference cell applied to MCG configuration (MCG reference cell configuration), and an operation according to each method is described in the following embodiment. Further, in the disclosure, the reference cell configuration is used interchangeably with a reference cell, reference configuration, and the like. Hereinafter, a method of supporting MCG configuration applied when continuous CPAC provided in the disclosure is performed will be described in detail.

### 1. First MCG Configuration Method

There is no reference cell configuration for the MCG configuration, and a target MCG configuration always includes a complete MCG configuration.
Each target candidate cell may provide a configuration by considering the MCG configuration in association with the SCG configuration that changes after CPC.

### 2. Second MCG Configuration Method

New MCG reference cell configuration for the MCG configuration is introduced and transferred to the terminal along with the SCG reference cell configuration. By this method, signaling overhead for the MCG configuration that can be changed together when PSCell is changed during continuous CPAC operation can be reduced.
MCG reference cell configuration is determined through inter-node negotiation with target candidate cells and is determined by a source MN.
Target candidate cells generate the MCG and SCG configurations, which are applied after continuous CPACs are applied based on the reference cell configuration for MCG and SCG received from the MN, based on delta configuration, and transfer the MCG and SCG configuration to the MN.
Reference cell configuration may be common configuration information that is generated by determining configurations that may be applied to the configuration information of target candidate cells in common, and may include, for example, bearer configurations that may be applied to multiple SNs (in the same DU) in common, L2 configurations such as MAC/RLC, channel measurement configurations, and the like. In addition, the reference cell configuration may also include specific configurations that are included in ServingCellConfigCommon.
Delta configuration refers to receiving only a configuration additionally configured on the reference cell from target candidate cells based on the reference cell configuration and configuring a complete cell configuration through “reference cell configuration+configuration for reception from target candidate cells.”
If the reference cell configuration does not exist, the configuration for reception from the target candidate cells may always be configured by complete configurations.

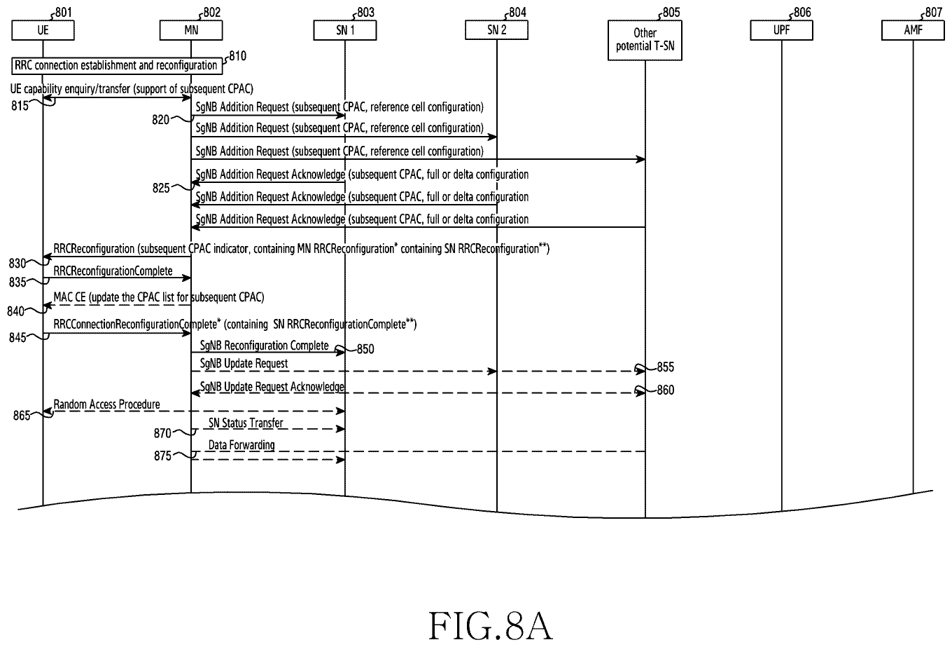

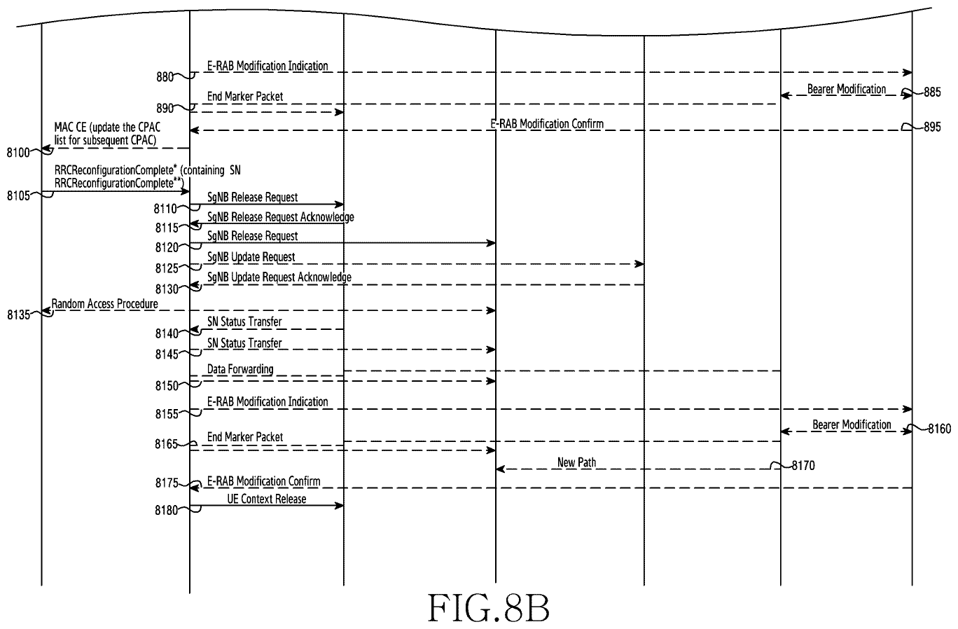

FIG. 8A illustrates an overall operation of performing a conditional PSCell addition and change procedure continuously according to an embodiment applied to the disclosure, and FIG. 8B illustrates an overall operation of performing a conditional PSCell addition and change procedure continuously according to an embodiment applied to the disclosure. In particular, this embodiment describes a procedure in which a terminal simultaneously receives configurations for CPA and CPC (conditions for CPAC and SCG-related RRC configurations) from a base station in a state in which DC is not established, and stores and manages the corresponding configuration information. Particularly, an operation is included that allows the MCG configuration and SCG configuration to be changed together in a continuous CPAC operation, which is main content of the disclosure.

In operation 810, a UE 801 may proceed an RRC connection establishment procedure with a master node (MN)/base station 802 and perform RRC configuration. In operation 815, the UE 801 and the MN base station 802 identifies UE capability through the procedure of requesting and delivering UE capability request (UECapabilityEnquiry) and UE capability information (UECapabilityInformation) messages. It is characterized in that the corresponding UE capability includes an indicator indicating whether the UE supports continuous CPAC. The UE capability may be transferred using one of the feature set methods for each UE, each band, or each band combination, and may be transferred separately for the UE capability for CPA and UE capability for CPC.

In operation 820, the MN base station 802 may identify whether it is necessary to add an SN for the UE, and inquire of SN nodes 803, 804, and 805 that can be candidates (or potential candidates) about whether the SN nodes are available for SN addition for the UE. The corresponding procedure may be performed through a SgNB addition request procedure in operation 820 and a SgNB addition request Acknowledge procedure in operation 825 between the MN base station 802 and the respective SN nodes. In the above procedure, content for identifying whether continuous CPAC application is possible may be added. That is, continuous CPAC application identification indicator and identification indicator may be included in the SgNB addition request and the SgNB addition request Acknowledge. Furthermore, in operations 820 above, the reference cell configuration information for the MCG and the SCG, which are referenced when configuring CPAC, may be transferred together. Although not illustrated, the MN and the candidate SN may perform an inter-node coordination procedure to determine the MCG and SCG reference cell configuration information that are used for reference when continuous CPAC operations are performed through a separate procedure.

In operation 825, the candidate SN nodes may transfer the configuration for CPAC, as configurations (MCG and SCG configurations) obtained by applying a delta configuration, or as a complete configuration, through sgNB addition request Acknowledge, which is a response message to the sgNB addition request. It is assumed that the delta configuration is performed according to the request, but when a reference cell configuration is not received from the SN node, the complete configuration may be transferred. In addition, continuous CPAC application identification indicator and an identification indicator may be included in the Xn message exchange procedure and the RRC inter-node messages (CG-Config and CG-ConfigInfo).

In operation 830, the MN base station 802 includes, in an RRC configuration message of the MN base station, the CPAC-related configuration (condition for CPAC and SCG-related RRC configuration) received from the candidate SNs that allow the UE to perform the SN addition or the CPAC, particularly, in operations 820/725, and transmits the same to the UE. In an EN-DC situation, the CPAC-related configuration for the SN is encapsulated in an RRCConnectionReconfiguration message and in NE-DC and NR-DC situations, the CPAC-related configuration for the SN is encapsulated in an RRCReconfiguration message, and the same is transmitted to the UE. Referring to FIGS. 8A and 8B, the case of NR-DC will be assumed and described. The SN CPAC-related configurations included in the RRC configuration may follow the structure and method described in FIG. 7 above. In other words, the MN base station 802 simultaneously configures the CPA and CPC configurations to support the conditional PSCell addition and change procedure continuously, and includes the CPA and CPC configurations in the RRC configuration and transfers the same to the UE. When the MN base station 802 transfers the CPAC-related configuration (e.g., conditions for SN CPAC, MCG and SCG configurations that are applied after SN CPAC has been performed, etc.) to the UE, the MN base station may include, in the CPAC-related configuration, an indicator indicating that a continuous CPAC operation is supported (for example, the following subsequentCG-Change field) in the corresponding CPAC operation. The UE that has received the corresponding indicator may keep/store a related CPAC configuration even after SCG change. That is, the UE does not release or delete the received CPAC configuration, continues to identify the stored CPAC conditions even after the SCG change, and if a specific condition is satisfied, triggers the CPC and performs the CPC operation from a previous PSCell to a target PSCell. The corresponding operation may be continued until a separate release command for a continuous CPAC operation is transmitted from the base station.

In operation 835, the UE transfers an RRCReconfigurationComplete message to the MN base station 802 in response to the received RRC configuration (including the configuration for MN and SN, especially CPAC-related configuration). Thereafter, in case that the CPAC-related condition received from a specific SN (SN 1) 803 is satisfied, the UE triggers the SN addition procedure for the corresponding SN (SN 1) 803. That is, in operation 840, the UE generates an MN RRCReconfigurationComplete including the SN RRCReconfigurationComplete message for the SN for which the SN addition procedure is triggered (the SN for which the CPA condition is satisfied) and transmits the same to the MN base station 802. In operation 850, the MN base station 802 transfers the SgNB reconfiguration complete message to the SN base station 803 for which the corresponding CPA condition is satisfied, that is, the SN base station 803 to which the UE performs the SN addition and notifies the SN base station 803 of the SN addition operation of the UE. In addition, in operation 855, the MN base station 802 performs a procedure of inquiring of the candidate SN base stations to which the SN has not been added about whether the CPAC configuration transferred to the UE is valid. That is, in operation 855, the MN base station 802 requests the candidate SN base stations of whether the previously provided (continuous) CPAC configuration is valid even after the SCG change or whether it is necessary to update the previously provided (continuous) CPAC configuration. The corresponding message may be a SgNB update request message or another Xn message or may be an RRC inter-node message.

In operation 860, each of the candidate SNs transfers a SgNB release request acknowledge or RRC inter-node message including (continuous) CPAC configuration update information in response to the message. The procedures in operations 855 and 860 may be omitted depending on implementations. In addition, the delta configuration and complete configuration requests for the CPAC configurations and the CPAC configurations according thereto may be performed in the corresponding operation as well.

In operation 865, the UE performs a random access procedure for adding an SN to the SN for which CPA is triggered. This operation may be performed only in the case where the update of security key is required, and may be omitted in other cases. In operation 870, the MN base station 802 transfers the sequence number (SN) status to the SN base station 803, and may perform a procedure of transferring the data from the UPF 806 to the SN base station 803 in operation 875. Further, in operation 880, the MN base station 802 transfers a PDU session resource modification indicator to an AMF 807 as an operation for path update. In operation 885, the AMF 807 and the UPF 806 perform the bearer modification procedure and, in operation 890, the UPF 806 transfers the PDU packet including an end marker to the MN base station 802 to indicate the modification of a previous bearer. In operation 895, the AMF 807 transfers a PDU session resource modification identification message indicating that the PDU session resource modification has been completed to the MN base station 802.

As described above, the process of instructing updating of the continuous CPAC operation may be triggered at any time by an identification between the base stations. For example, as in operation 8100, information about the SN to which the continuous CPAC operation is applied through a new MAC control element (CE) may be updated. Alternatively, the CPAC configurations may be explicitly modified and released through RRC messages. In the corresponding operation, the CPA and CPC configurations that are the focus of the embodiments of the disclosure may be transferred simultaneously, and the MAC CE update may also indicate the validity of the continuous CPA and CPC configurations.

Thereafter, in case that the CPAC-related condition received from a specific SN is satisfied, the UE triggers the SN change procedure for the corresponding SN. That is, in operation 8105, the UE generates an MN RRCReconfigurationComplete including the SN RRCReconfigurationComplete message for the SN (SN 2) 804 for which the SN change procedure is triggered (the SN for which the CPAC condition is satisfied), and transmits the same to the MN base station 802. In operation 8110, the MN base station 802 transfers a SgNB release request message requesting SCG configuration release to the source SN base station 803, and in operation 8115, the source SN base station 803 responds to the request by transmitting a SgNB release request acknowledge message. In operation 8120, the MN base station 802 transfers the SgNB reconfiguration complete message to the target SN base station (SN 2) 804 for which the corresponding CPAC condition is satisfied, that is, the target SN base station (SN 2) 804 to which the UE performs the SN change, and notifies the target SN base station of the SN change operation of the UE. In addition, in operation 8125, the MN base station 802 may perform a procedure of inquiring of the candidate SN base station 805 for which the SN change has not been performed about whether the CPAC configuration transferred to the UE is valid.

That is, in operation 8125, the MN base station 802 requests the candidate SN base station 805 of whether the previously provided (continuous) CPAC configuration is valid even after the SCG change or of whether it is necessary to update the previously provided (continuous) CPAC configuration. The corresponding message may be a SgNB update request message or another Xn message or may be an RRC inter-node message. In operation 8130, each of the candidate SNs transfers a SgNB release request acknowledge or RRC inter-node message including (continuous) CPAC configuration update information in response to the message. The procedures in operations 8125 and 8130 may be omitted depending on implementations. In the corresponding operation, the delta configuration and complete configuration requests for the CPAC configurations and the CPAC configurations according thereto may be performed. In addition, the continuous CPAC operation that can be repeatedly performed thereafter is omitted in FIGS. 8A and 8B, but the UE may perform related operations (CPC trigger and CPC execution) by continuously applying the received CPAC configuration.

In operation 8135, the UE performs a random access procedure for SN change with respect to the target SN (SN 2) 804 for which CPC is triggered. This operation may be performed only in the case where the update of security key is required, and may be omitted in other cases. In operation 8140, the MN base station 802 may receive the sequence number (SN) status from the source SN base station 803 and transfers the received SN status to the target SN base station 804 in operation 8145. In operation 8150, the MN base station 802 may perform a procedure of transferring the data from the UPF 806 to the target SN base station 804. Further, in operation 8155, the MN base station 802 transfers a PDU session resource change indicator to an AMF 807 as an operation for path update. In operation 8160, the AMF 807 and the UPF 806 perform the bearer modification procedure and, in operation 8165, the UPF 806 transfers the PDU packet including an end marker to the MN base station 802 to indicate the modification of a previous bearer. In operation 8170, the UPF 806 may indicate a new path to the target SN base station 804. In operation 8175, the AMF 807 transfers a PDU session resource modification identification message indicating that the PDU session resource modification has been completed to the MN base station 802. In operation 8180, the MN base station 802 may instruct the source SN base station 803 to release the UE context.

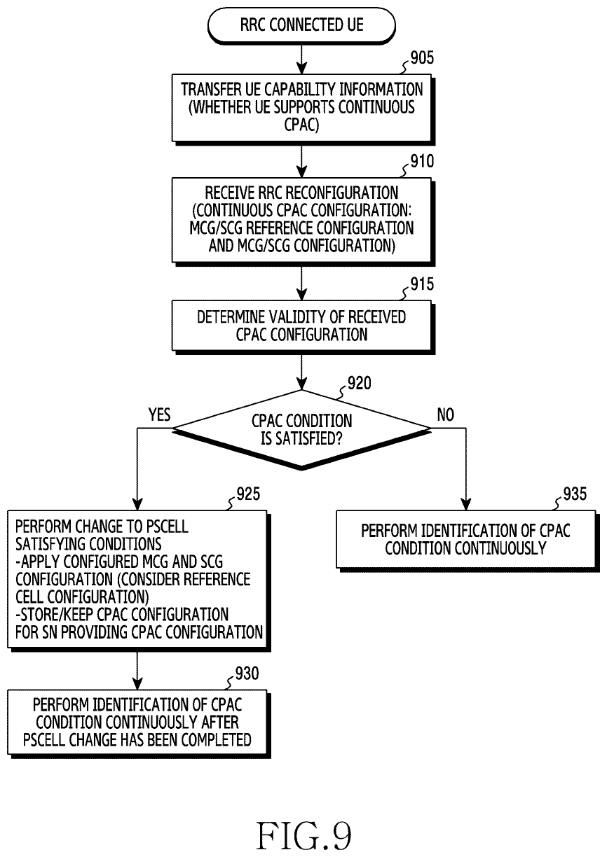

FIG. 9 illustrates a method of a UE operation according to various embodiments of the present disclosure where a UE operation is performed when conditional PSCell addition and change are continuously applied.

In operation 905, a UE transfers the UE capability to a base station through a UE capability information (UECapabilityInformation) message according to a request of the base station (UECapabilityEnquiry). The corresponding UE capability includes an indicator indicating whether the UE supports continuous CPAC. The UE capability may be transferred using one of the feature set methods for each UE, each band, or each band combination, and may be transmitted separately for the UE capability for CPA and the UE capability for CPC. In operation 910, the UE may receive an RRC configuration from the base station, and basic configurations for data transmission and reception may be provided in the corresponding configuration. In addition, the RRC configuration includes CPAC configuration for a plurality of SNs and an indicator indicating that continuous CPAC is applied. With respect to the received CPAC configuration, the MCG and SCG configurations obtained by applying a delta configuration to the reference cell configuration may be transferred along with the MCG and SCG reference cell configurations.

In this case, the UE may decode the corresponding configuration and apply the delta configuration based on the reference cell configuration to generate, store, and manage the entire cell configurations (in operation 915). Alternatively, in the corresponding operation, the received configuration may be stored and managed as is, and when CPAC is actually triggered, the configuration may be decoded based on the reference cell configuration and applied to the target cell. In addition, in the corresponding operation, continuous CPA and CPC configurations, which are the main issues of the disclosure, may be received at the same time, and the UE may apply or store the corresponding configuration as it is and then perform the CPAC operation according to the conditions.

In operation 920, when the UE receives the RRC configuration and if the UE continuously identifies CPAC triggering conditions included in the CPAC configuration to identify that the condition is satisfied, the UE adds a PSCell that satisfies the condition or performs change to the corresponding PSCell in operation 925. That is, the UE applies the MCG and SCG configuration information provided in the CPAC configuration, and in case that random access is required for the corresponding PSCell, random access is performed and uplink synchronization is matched. In other words, the UE performs an operation for PSCell change and additionally stores/keeps CPAC configuration for the SN providing CPAC configuration. Here, the stored configuration also includes reference cell configuration information for the MCG and SCG. In other words, the storage/keep of the CPAC-related configuration for the SN providing the CPAC configuration may be updated according to the RRC configuration provided in operation 910. That is, the configuration information may be updated according to the most recently provided information. In operation 930, the UE continuously identifies the channel measurement value and CPAC condition based on the stored CPAC configuration for the SN supporting continuous CPAC operation after completing the change to the target PSCell and performs the CPAC operation. Thereafter, the UE may perform operations after operation 910 or operation 915 according to base station signaling.

When the UE receives the RRC configuration in operation 920, the UE continuously identifies the CPAC triggering conditions included in the CPAC configuration in operation 935. The UE may perform operations after operation 910 or operation 915 according to base station signaling.

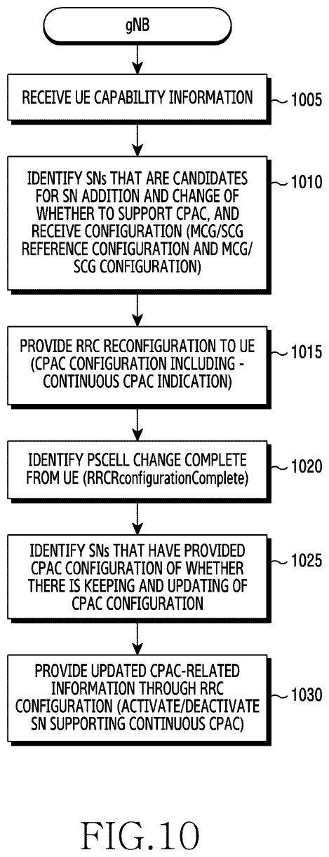

FIG. 10 illustrates a method of a base station when conditional PSCell addition and change are continuously applied according to various embodiments of the present disclosure.

In operation 1005, the base station transmits a UE capability request (UECapabilityEnquiry) message to the UE in order to acquire the UE capability, and accordingly receives the UE capability from the UE through the UE capability information (UECapabilityInformation) message. The corresponding UE capability may include an indicator indicating whether the UE supports continuous CPAC. The UE capability may be transferred using one of the feature set methods for each UE, each band, or each band combination, and may be transmitted separately for CPA and CPC. The base station identifies the corresponding UE capability and determines whether to instruct continuous CPAC operation through an RRC configuration thereafter. In operation 1010, the base station may perform negotiation with SNs that are candidates for SN addition and change to identify whether to support continuous CPAC and to perform related configuration.

In operation 1010, the base station may identify whether each SN supports continuous CPAC, and include a coordination to generate MCG and SCG reference cell configuration information. In case that the MCG and SCG reference cell configuration information is determined, the MN base station may receive the CPAC configurations for the CPAC candidate SNs, as a delta configuration about the MCG and SCG reference cell configuration information, or as a complete configuration. Based on this operation, the base station may transfer the CPAC-related configuration to the UE through RRC reconfiguration in operation 1015. That is, an indicator indicating continuous CPAC operation according to the configurations provided by each SN may be provided to the UE together with the CPAC configuration. Further, the MCG and SCG reference cell configuration information may be transferred along with the MCG and SCG configuration information for the target candidate cells.

In operation 1020, the base station receives an RRCReconfigurationComplete message from the UE, in response to the RRC reconfiguration that has provided the SN configuration (CPAC configuration) (receiving the SN RRC complete message included in the MN RRC message) and identifies that PSCell change is completed. In operation 1025, the MN base station may identify SNs that have provided CPAC configuration of whether there is keeping and updating of the (continuous) CPAC configuration. After negotiation with the SN nodes in the above operation, when the (continuous) CPAC configuration is updated, the base station updates the CPAC configurations through the RRC configuration. In addition, since there may be updates to the continuous CPAC procedure at any time due to the operation of the base station below, the procedures described in 1010 to 1030 may be re-performed through the identification procedure between base stations.

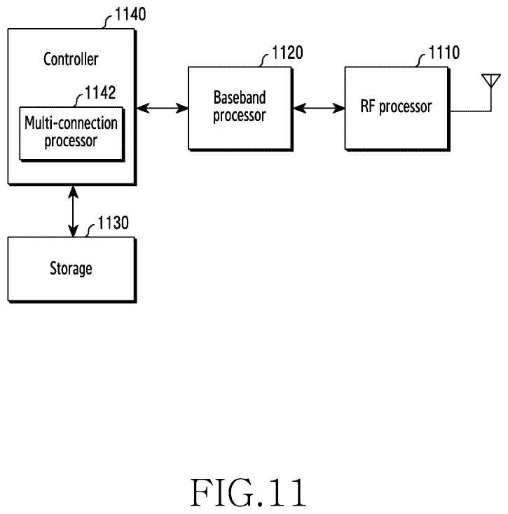

FIG. 11 illustrates an internal structure of a UE according to various embodiments of the present disclosure.

Referring to FIG. 11, the UE includes a radio frequency (RF) processor 1110, a baseband processor 1120, a storage 1130, and a controller 1140.

The RF processor 1110 performs the functions of signal band conversion and amplification and the like to transmit and receive signals through a radio channel. That is, the RF processor 1110 up-converts the baseband signal provided from the baseband processor 1120 into an RF band signal and then transmits the signal through the antenna, and down-converts the RF band signal received through the antenna into a baseband signal. For example, the RF processor 1110 may include a transmission filter, a reception filter, an amplifier, a mixer, an oscillator, a digital to analog convertor (DAC), an analog to digital convertor (ADC), and the like. Although only one antenna is illustrated in FIG. 11, the UE may include multiple antennas. In addition, the RF processor 1110 may include multiple RF chains. Further, the RF processor 1110 may perform beamforming. For the beamforming, the RF processor 1110 may adjust the phase and magnitude of each of the signals transmitted/received through multiple antennas or antenna elements. The RF processor may perform MIMO operation and may receive multiple layers when performing the MIMO operation.

The baseband processor 1120 performs the function of converting between baseband signals and bit strings according to the physical layer protocol of the system. For example, the baseband processor 1120 performs coding and modulation on the transmission bit string to generate complex symbols when transmitting data. In addition, when receiving data, the baseband processor 1120 performs demodulation and decoding on the baseband signal provided from the RF processor 1110 to recover the received bit string. For example, in case of following an orthogonal frequency division multiplexing (OFDM) scheme, the baseband processor 1120 performs coding and modulation on the transmission bit string to generate complex symbols, maps the complex symbols to subcarriers, performs inverse fast Fourier transform (IFFT) on the subcarriers, and inserts cyclic prefix (CP) to generate OFDM symbols when transmitting data. In addition, when receiving data, the baseband processor 1120 separates the baseband signal provided from the RF processor 1110 into OFDM symbols, restores the signal mapped to the subcarriers by the fast Fourier transform (FFT) computation, and performs demodulation and decoding to restore the reception bit string.

The baseband processor 1120 and the RF processor 1110 transmit and receive signals as described above. Accordingly, the baseband processor 1120 and the RF processor 1110 may be referred to as a transmitter, a receiver, a transceiver, or a communication unit. Further, at least one of the baseband processor 1120 and the RF processor 1110 may include a plurality of communication modules for supporting different radio access technologies. In addition, at least one of the baseband processor 1120 and the RF processor 1110 may include different communication modules for processing different frequency band signals. Examples of different radio access technologies may include WLANs (e.g., IEEE 802.11) and cellular networks (e.g., LTE). Examples of different frequency bands may include super high frequency (SHF) frequency bands (e.g., 2.N RHz, N Rhz) and millimeter wave frequency bands (e.g., 60 GHz).

The storage 1130 stores basic programs for the operation of the terminal, application programs, and data such as configuration information. In particular, the storage 1130 may store information about a secondary access node with which the terminal performs radio communication using a secondary radio access technology. The storage 1130 provides stored data in response to a request from the controller 1140.

The controller 1140 control the overall operation of the terminal. For example, the controller 1140 transmits/receives signals through the baseband processor 1120 and the RF processor 1110. Further, the controller 1140 writes data to the storage 1130 and reads data from the storage 1130. To this end, the controller 1140 may include at least one processor. For example, the controller 1140 may include a communication processor (CP) for controlling communications and an application processor (AP) for controlling higher layers such as application programs. The controller 1140 may further include a multi-connection processor 1142 to support multiple connections.

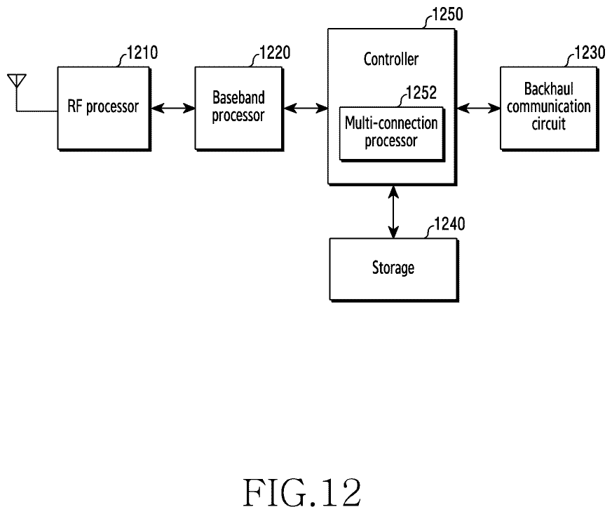

FIG. 12 illustrates a configuration of a base station according to various embodiments of the present disclosure.

As shown in FIG. 12, the base station includes an RF processor 1210, a baseband processor 1220, a backhaul communication circuit 1230, a storage 1240, and a controller 1250.

The RF processor 1210 performs the function of signal band conversion, amplification and the like to transmit and receive signals through a radio channel. That is, the RF processor 1210 up-converts the baseband signals provided from the baseband processor 1220 into RF band signals, and then transmits the signal through the antennas, and down-converts the RF band signals received through the antennas into baseband signals. For example, the RF processor 1210 may include a transmission filter, a reception filter, an amplifier, a mixer, an oscillator, a DAC, an ADC, and the like. Although only one antenna is depicted in FIG. 12, the first access node may include multiple antennas. In addition, the RF processor 1210 may include multiple RF chains. Furthermore, the RF processor 1210 may perform beamforming. For the beamforming, the RF processor 1210 may adjust the phase and magnitude of each of the signals transmitted/received through multiple antennas or antenna elements. The RF processor may perform downlink MIMO operations to transmit signals on one or more layers.

The baseband processor 1220 performs the function of converting between baseband signals and bit strings according to the physical layer protocol of a first radio access technology. For example, the baseband processor 1220 performs coding and modulation on the transmission bit string to generate complex symbols when transmitting data. The baseband processor 1220 also performs demodulation and decoding on the baseband signals provided from the RF processor 1210 to recover the received bit string when receiving data. For example, in the case of following an OFDM scheme, the baseband processor 1220 performs coding and modulation on a transmission bit string to generate complex symbols, maps the complex symbols to subcarriers, and then performs IFFT computation and CP insertion to configure OFDM symbols, when transmitting data.

In addition, the baseband processor 1220 separates the baseband signals provided from the RF processor 1210 into OFDM symbols, recovers the signals mapped to the subcarriers by the FFT computation, and performs demodulation and decoding to recover the reception bit strings, when receiving data. The baseband processor 1220 and the RF processor 1210 perform signal transmission and reception as described above. Accordingly, the baseband processor 1220 and the RF processor 1210 may be referred to as a transmitter, a receiver, a transceiver, a communication unit, or a wireless communication unit.

The backhaul communication circuit 1230 provides interfaces for communicating with other nodes in a network. That is, the backhaul communication circuit 1230 converts a bit string to be transmitted from the main base station to another node, for example, an auxiliary base station, a core network, etc. into a physical signal, and converts a physical signal received from another node into a bit string.

The storage 1240 stores basic programs, application programs, and data such as configuration information for the operation of the main base station. In particular, the storage 1240 may store information about bearers allocated to the connection terminals and measurement results reported by the terminals. Further, the storage 1240 may store information as criteria for determining whether to enable or disable multi-connectivity of the terminal. Furthermore, the storage 1240 provides stored data in response to requests from the controller 1250.

The controller 1250 controls the overall operations of the main base station. For example, the controller 1250 transmits and receives signals through the baseband processor 1220 and the RF processor 1210, or through the backhaul communication circuit 1230. In addition, the controller 1250 writes data to the storage 1240 and reads data from the storage 1240. To this end, the controller 1250 may include at least one processor. The controller 1250 may further include a multi-connection processor 1252 to support multiple connections.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein but should be defined by the appended claims and equivalents thereof.

Furthermore, the methods of the disclosure as described above in conjunction with FIG. 1 to FIG. 12 may include methods in which one or more of the drawings are combined according to various implementations. For example, the embodiments described in FIG. 1 to FIG. 12 may be combined to be connected (performed) as one flow. In addition, all or a part of an embodiment may be performed in combination with all or a part of one or more other embodiments. The disclosure may include methods in which one or more of the drawings are combined according to various implementations.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station in a wireless communication system, the method comprising:
generating a radio resource control (RRC) message including a configuration on a subsequent conditional primary secondary cell group (SCG) cell (PSCell) addition or change (CPAC), the configuration including information on a candidate SCG configuration of a candidate PSCell and a master cell group (MCG) configuration associated with the candidate SCG configuration; and
transmitting, to a user equipment (UE), the RRC message including the configuration,
wherein the configuration includes a reference configuration for the candidate SCG configuration.

2. The method of claim 1, wherein the candidate SCG configuration comprises a delta configuration for the reference configuration.

3. The method of claim 1, wherein the reference configuration includes one reference configuration, wherein the one reference configuration includes a first part associated with an MCG and a second part associated with an SCG.

4. The method of claim 3, wherein the first part is generated by a master base station and the second part is generated by a secondary base station.

5. The method of claim 4, wherein the base station comprises the master base station or the secondary base station.

6. A method performed by a user equipment (UE) in a wireless communication system, the method comprising:
receiving, from a base station, a radio resource control (RRC) message including a configuration on a subsequent conditional primary secondary cell group (SCG) cell (PSCell) addition or change (CPAC), the configuration including information on a candidate SCG configuration of a candidate PSCell and a master cell group (MCG) configuration associated with the candidate SCG configuration; and
identifying the configuration included in the RRC message,
wherein the configuration includes a reference configuration for the candidate SCG configuration.

7. The method of claim 6, wherein the candidate SCG configuration comprises a delta configuration for the reference configuration.

8. The method of claim 6, wherein the reference configuration includes one reference configuration, wherein the one reference configuration includes a first part associated with an MCG and a second part associated with an SCG.

9. The method of claim 8, wherein the first part is associated with the MCG of a master base station and the second part is associated with the SCG of a secondary base station.

10. The method of claim 9, wherein the base station comprises the master base station or the secondary base station.

11. A base station in a wireless communication system, the base station comprising:
a transceiver; and
a controller coupled with the transceiver and configured to:
generate a radio resource control (RRC) message including a configuration on a subsequent conditional primary secondary cell group (SCG) cell (PSCell) addition or change (CPAC), the configuration including information on a candidate SCG configuration of a candidate PSCell and a master cell group (MCG) configuration associated with the candidate SCG configuration, and
transmit, to a user equipment (UE), the RRC message including the configuration,
wherein the configuration includes a reference configuration for the candidate SCG configuration.

12. The base station of claim 11, wherein the candidate SCG configuration comprises a delta configuration for the reference configuration.

13. The base station of claim 11, wherein the reference configuration includes one reference configuration, wherein the one reference configuration includes a first part associated with an MCG and a second part associated with an SCG.

14. The base station of claim 13, wherein the first part is generated by a master base station and the second part is generated by a secondary base station.

15. The base station of claim 14, wherein the base station comprises the master base station or the secondary base station.

16. A user equipment (UE) in a wireless communication system, the UE comprising:
a transceiver; and
a controller coupled with the transceiver and configured to:
receive, from a base station, a radio resource control (RRC) message including a configuration on a subsequent conditional primary secondary cell group (SCG) cell (PSCell) addition or change (CPAC), the configuration including information on a candidate SCG configuration of a candidate PSCell and a master cell group (MCG) configuration associated with the candidate SCG configuration, and
identify the configuration included in the RRC message,
wherein the configuration includes a reference configuration for the candidate SCG configuration.

17. The UE of claim 16, wherein the candidate SCG configuration comprises a delta configuration for the reference configuration.

18. The UE of claim 16, wherein the reference configuration includes one reference configuration, wherein the one reference configuration includes a first part associated with an MCG and a second part associated with an SCG.

19. The UE of claim 18, wherein the first part is associated with the MCG of a master base station and the second part is associated with the SCG of a secondary base station.

20. The UE of claim 19, wherein the base station comprises the master base station or the secondary base station.
